(19) United States
(12) Patent Application Publication
(10) Pub. No.: US 2016/0210227 A1
(43) Pub. Date: Jul. 21, 2016

(54) METHOD AND SYSTEM FOR IDENTIFYING AREAS OF IMPROVEMENTS IN AN ENTERPRISE APPLICATION

(71) Applicant: Wipro Limited, Bangalore (IN)

(72) Inventor: Kavitha Sridhar, Bangalore (IN)

(21) Appl. No.: 14/656,265

(22) Filed: Mar. 12, 2015

(30) Foreign Application Priority Data
Jan. 21, 2015 (IN) 304/CHE/2015

(51) Int. Cl. G06F 11/36

(52) U.S. Cl. CPC G06F 11/3692; G06F 11/3696; G06F 11/3604

(57) ABSTRACT

The present disclosure relates to a method and a system for identifying areas of improvements in an enterprise application. In one embodiment, static and dynamic analysis information associated with the enterprise application is received. Further, responses to questions related to the enterprise application are also received. The received information and responses are analyzed and areas of improvements are identified based on the analyzed static and dynamic analysis information and responses complying with one or more implementation recommendations stored. The present disclosure also provides reporting services for generating report based on the identified areas of improvements in enterprise applications.

This application claims the benefit of Indian Patent Application No. 304/CHE/2015 filed Jan. 21, 2015, which is hereby incorporated by reference in its entirety.

### FIELD

The present subject matter is related, in general to enterprise applications, and more particularly, but not exclusively to method and system for identifying areas of improvements in enterprise applications.

### BACKGROUND

With advances in computer technologies, business and other organizations are increasingly implementing more complex enterprise architectures and applications to drive the architectures. Enterprise applications are complex, scalable and component-based and are distributed across geography and hosted in data centers. The primary aim of implementing enterprise applications is to make these component-based applications work together to meet desired response time, security compliance, and resilience. In many cases, the applications are down with increased volume of data or slowed down during peak time period hence delaying the response time. In other cases, there are bottlenecks in the applications, and factors like high infrastructure configurations and caching add to increasing complexity.

Furthermore, there may be several instances where the resilience of the enterprise applications is poor due to long duration processing of data and increase in volume of data to be processed.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of identifying areas of improvements in an enterprise application. The method comprising receiving static and dynamic analysis information associated with the enterprise application and receiving one or more responses for one or more questions related to the enterprise application. Upon receiving the static and dynamic analysis information and responses, the method analyzes the received information and responses. The method further comprises identifying one or more areas of improvements based on the analyzed static and dynamic analysis information and responses complying with one or more implementation recommendations stored in a reference repository.

Further, the present disclosure relates to a system for identifying areas of improvements in an enterprise application. The system comprises an application user interface (UI) configured to receive static and dynamic analysis information associated with the enterprise application. The system further comprises a processor and a memory communicatively coupled to the processor, wherein the memory stores processor-executable instructions, which, on execution, cause the processor to receive, one or more responses for one or more questions related to the enterprise application. The processor is furthermore configured to analyze the static and dynamic analysis information and responses and identify one or more areas of improvements based on the analyzed static and dynamic analysis information and responses complying with one or more implementation recommendations stored in the memory.

Furthermore, the present disclosure relates to a non-transitory computer readable medium including instructions stored thereon that when processed by at least one processor cause a system to perform the act of receiving static and dynamic analysis information associated with the enterprise application. Further, the instructions cause the processor to receive one or more responses for one or more questions related to the enterprise application and analyze the static and dynamic analysis information and responses. Further, the instructions cause the processor to identify one or more areas of improvements based on the analyzed static and dynamic analysis information and responses complying with one or more implementation recommendations stored in a reference repository.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates exemplary network architecture for identifying areas of improvements in an enterprise application in accordance with some embodiments of the present disclosure;

FIG. 2 illustrates a block diagram of an identification system in accordance with some embodiments of the present disclosure;

FIG. 3 illustrates a flowchart of a method of identifying areas of improvements in an enterprise application in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for identifying areas of improvements in an enterprise application. In one embodiment, static and dynamic analysis information associated with the enterprise application is received. Further, responses to questions related to the enterprise application are also received. The received information and responses are analyzed and areas of improvements are identified based on the analyzed static and dynamic analysis information and responses complying with one or more implementation recommendations stored. The present disclosure also provides reporting services for generating report based on the identified areas of improvements in enterprise applications.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

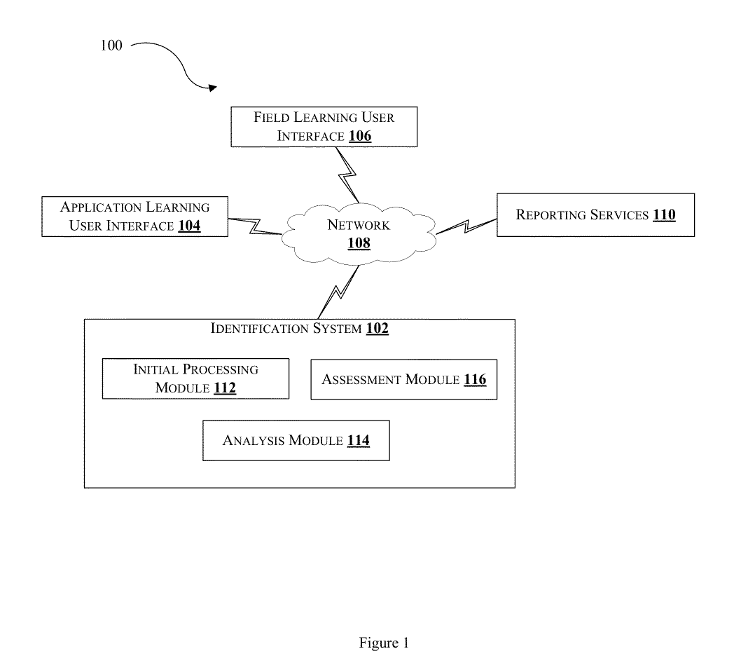

FIG. 1 illustrates exemplary network architecture 100 for identifying areas of improvements in an enterprise application in accordance with some embodiments of the present disclosure.

As shown in FIG. 1, the exemplary network architecture 100 comprises an identification system 102 or computing device for identifying areas of improvements in an enterprise application. In one embodiment, the identification system 102 is coupled with an application learning user interface (UI) 104 and a field learning user interface (UI) 106 via a communication network 108. The application UI 104 receives information related to enterprise application from user and the field learning UI 106 receives feedback on accepted recommendations from the application team for improving the recommendations. The identification system 102 is also coupled with reporting services 110 via the communication network 108. The reporting services 110 enable generation of assessment report comprising the identified areas of improvement in enterprise applications.

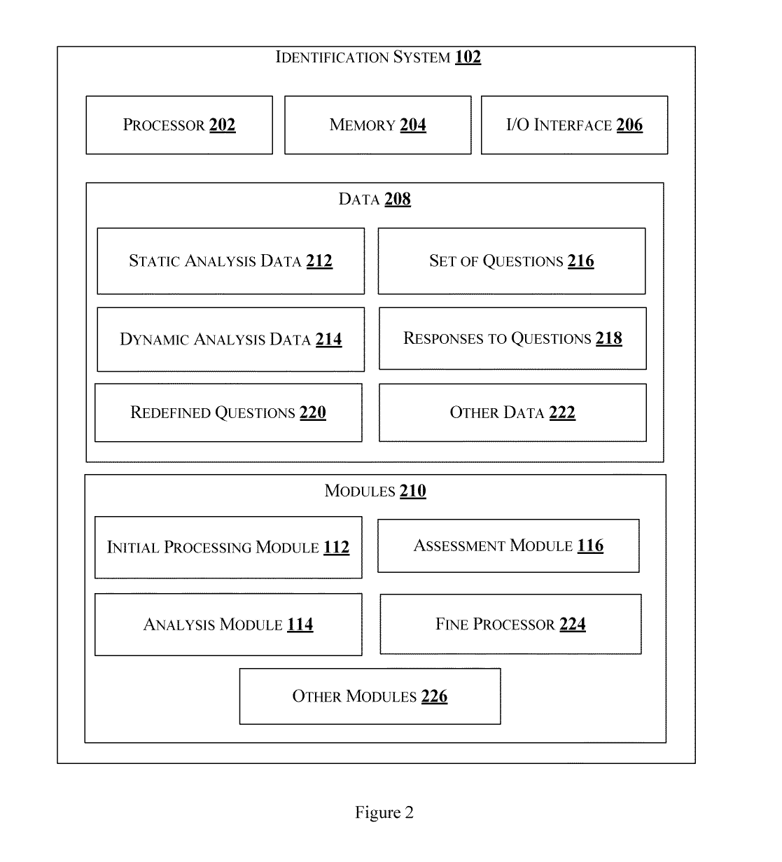

The identification system 102 comprises one or more components configured to enable identification of one or more areas of improvement related to the enterprise application. In one embodiment, the identification system 102 comprises at least an initial processing module 112, an analysis module 114 and an assessment module 116. The identification system 102 can be explained in detail with reference to FIG. 2. In one implementation, the exemplary identification system 102 includes a central processing unit (“CPU” or “processor”) 202, the memory 204 and an I/O interface 206. The I/O interface 206 is coupled with the processor 202 and an I/O device. The I/O device is configured to receive inputs via the I/O interface 206 and transmit outputs for displaying in the I/O device via the I/O interface 206.

The identification system 102 further comprises data 208 and modules 210. In one implementation, the data 208 and the modules 210 may be stored within the memory 204. In one example, the data 208 may include static analysis data 212, dynamic analysis data 214, set of questions 216, responses to questions 218, redefined questions 220, and other data 222. In one embodiment, the data 208 may be stored in the memory 204 in the form of various data structures. Additionally, the aforementioned data can be organized using data models, such as relational or hierarchical data models. The other data 222 may be also referred to as reference repository for storing recommended implementation approaches as reference data. The other data 222 may also store data, including temporary data and temporary files, generated by the modules 210 for performing the various functions of the identification system 102.

The modules 210 may include, for example, the initial processing module 112, the analysis module 114, the assessment module 116, and a fine processor 224. The modules 210 may also comprise other modules 226 to perform various miscellaneous functionalities of the identification system 102. It will be appreciated that such aforementioned modules may be represented as a single module or a combination of different modules.

In operation, the application learning UI 104 receives information relating to enterprise application. In one embodiment, the application learning UI 104 provides a set of questions 216 related to the enterprise application to the end user and receives the responses to the questions 218. For example, the application learning UI 104 provides a set of questions for understanding the application technology details like J2EE, .Net, Mainframe, etc. and architecture details like client server, N-Tier etc. The application learning UI 104 also provides set of questions 216 to the end user in order to receive information on the number of transactions, number of users, etc. to be handled by application. One or more questions include questions related to at least one of business requirements, deployment, technology and infrastructure requirements, architecture of application and information, data and security related risks, and management of the enterprise application. Based on the responses to the questions 218, the fine processor 224 redefines the set of questions and generates redefined set of questions 220 to be displayed to the end user.

The application learning UI 104 also receives information including static analysis data 212 and dynamic analysis data 214. In one example, the static analysis data 212 may include improvement areas obtained from source code or schema file data. The dynamic analysis data 214 may include run time data obtained during the execution of the source code.

The initial processing module 112 (alternately referred to as “pre-processor”) receives the static analysis data 212 and the dynamic analysis data 214 from the end user and processes the received data to generate processed data including initial processed improvement areas. In another embodiment, the initial processing module 112 processes the received static analysis data 212 and dynamic analysis data 214 as well as the responses to the questions 218 into corresponding processed static and dynamic analysis information and processed responses.

The analysis module 114 receives the processed data from the initial processing module 112 and identifies a subset of improvement areas aligning to the responses 218 received from the application learning UI 104. In one embodiment, the analysis module 114 receives the processed static and dynamic analysis data and the processed responses from the initial processing module 112 and determines a subset of improvement areas based on the processed responses stored in the memory 204. The analysis module 114 identifies a final set of improvement areas from the subset of improvement areas thus determined

The assessment module 116 generates an assessment report containing the final set of areas of improvement along with one or more recommended implementations. In another embodiment, the exemplary network architecture 100 comprises the reporting services 110 configured to generate report with the final set of areas of improvement in enterprises applications. The field learning UI 106 receives feedback on one or more accepted recommendations on implementation approaches from the application team and stores the accepted recommendations in the memory 104.

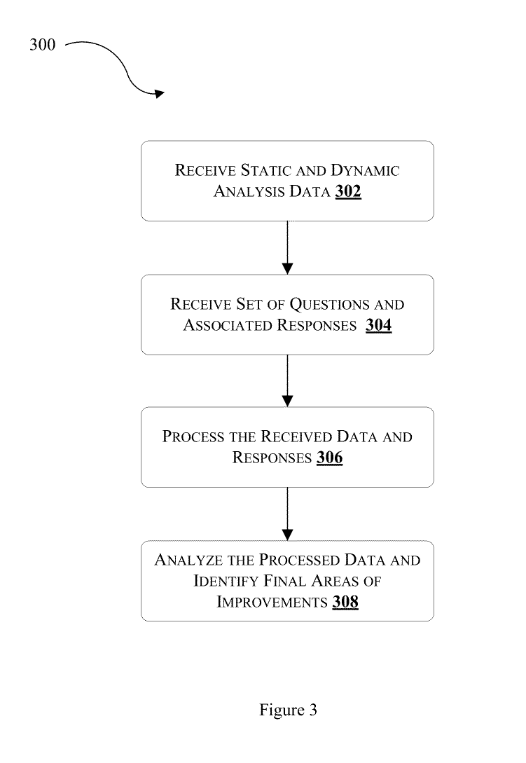

FIG. 3 illustrates a flowchart of method of identifying areas of improvements in an enterprise application in accordance with an embodiment of the present disclosure.

As illustrated in FIG. 3, the method 300 comprises one or more blocks implemented by the processor 202 of the identification system 102 for identifying areas of improvements in an enterprise application. The method3 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 302, receive static and dynamic analysis data. In one embodiment, the application learning UI 104 also receives information including static analysis data 212 and dynamic analysis data 214 associated with the enterprise application. In one example, the static analysis data 212 may include improvement areas obtained from source code or schema file data. The dynamic analysis data 214 may include run time data obtained during the execution of the source code. Let us illustrate an example, a sample .Net application with business logic being developed in C# in 5 modules (Module A, B, C, D, E) with asp.net web interface and SQL server 2008 as the backend database. Static analysis data and Dynamic analysis data is illustrated below in Tables A and B respectively.

TABLE A
Static Analysis Data

| Improvement Opportunities | No. Of Occurrences | Modules |
|---|---|---|
| Avoid hardcoded strings | 100 | UI, A, B, C, D, E |
| Use Union All instead of Union | 10 | E |
| Avoid tables without clustered index | 15 | E |
| Avoid Instantiation within the loop | 256 | B, C, D |
| Avoid Embedded SQL | 50 | A, B, C |
| Avoid cross site script vulnerabilities | 2 | UI |

TABLE B
Dynamic Analysis Data

| | | | Response |
|---|---|---|---|
| | | No. of times | Time in |
| Transaction Name | Component | called | msec |
| Check if the user is valid | UI, E, database | 80 | 1 |
| Place an order | UI, B, E, database | 30 | 2 |
| Check for availability of a | UI, B, E, database | 40 | 2 |
| product | | | |
| Create User | UI, A, database | 5 | 3 |

The outcome of analysis of Static and Dynamic data is illustrated in Table C below.

TABLE C

| | No. of |
|---|---|
| Analysis Findings | occurrences |
| Failure to connect to the database | 20 |
| High response time due to high memory usage | 30 |

At block 304, receive set of questions and associated responses. In one embodiment, the application learning UI 104 provides a set of questions 216 related to the enterprise application to the end user and receives the responses to the questions 218. For example, the application learning UI provides a set of questions related to at least one of business requirements, deployment, technology and infrastructure requirements, architecture of application and information, data and security related risks, and management of the enterprise application. A sample set of questions is illustrated below in Table D.

TABLE D

| Sample Questions | Response |
|---|---|
| What is the application type (mobile, rich client, web | Web |
| application or web services)? | Application |
| Is it distributed application? | No |
| What is the peak no. of users using this application | 500 |
| Is the application hosted in internet or intranet environment? | Intranet |
| What is your current business priority for the application? | Performance |
| Is there a caching mechanism being used for database | |
| connections? | |
| If the request is denied for some time during peak load, | |
| is it ok? | |
| Is there a scalability requirement for the application in | |
| pipeline? | |
| Is the application expected to have security compliance? | |
| Is there any interface with other applications? | |

Based on the responses to the questions 218, the fine processor 224 redefines the set of questions and generates redefined set of questions 220 to be displayed to the end user. Example set of redefined questions is illustrated below in Table E.

TABLE E

| Sample Questions | Response |
|---|---|
| What is the application type (mobile, rich client, web | Web |
| application or web services)? | Application |
| Is it distributed application? | No |
| What is the peak no. of users using this application | 500 |
| Is the application hosted in internet or intranet environment? | Intranet |
| What is your current business priority for the application? | Performance |
| Is there a caching mechanism being used for database | |
| connections? | |
| If the request is denied for some time during peak load, | |
| is it ok? | |

At block 306, process the received data and responses. In one embodiment, the initial processing module 112 (alternately referred to as “pre-processor”) receives the static analysis data 212 and the dynamic analysis data 214 from the end user and processes the received data to generate processed data including initial processed improvement areas (illustrated in Table F below).

TABLE F

| Initial Processed Improvement | No. Of | |
|---|---|---|
| Opportunities | Occurrences | Modules |
| Use Union All instead of Union | 10 | E |
| Avoid tables without clustered index | 15 | E |
| Avoid Instantiation within the loop | 90 | B |
| Usage of Stored Procedures instead | 30 | B |
| of embedded SQL is recommended | | |
| Implement the database connection pool | NA | NA |

In another embodiment, the initial processing module 112 processes the received static analysis data 212 and dynamic analysis data 214 as well as the responses to the questions 218 into corresponding processed static and dynamic analysis information and processed responses.

At block 308, analyze the processed data and identify final areas of improvements. In one embodiment, the analysis module 114 receives the processed data from the initial processing module 112 and identifies a subset of improvement areas aligning to the answers received from the application learning UI 104. In one embodiment, the analysis module 114 receives the processed static and dynamic analysis data and the processed responses from the initial processing module 112 and determines a subset of improvement areas based on the processed responses stored in the memory 204. The analysis module 114 identifies a final set of improvement areas from the subset of improvement areas.

As illustrated in Table G, “Avoid tables without clustered index” is eliminated as it a known feature of SQL Server 2008. “Avoid Embedded SQL” is also eliminated as there is no network connectivity between the modules and the database

TABLE G

| Improvement | | |
|---|---|---|
| Opportunities | No. | |
| from | Of | |
| Analysis Module | Occurrences | Modules |
| Use Union All instead of Union | 10 | E |
| Avoid Instantiation within the loop | 90 | B |
| Implement the database connection | | |
| pool | | |

The assessment module 116 generates assessment report containing the final set of areas of improvement along with one or more recommended implementations as illustrated below in Table H. In another embodiment, the exemplary network architecture 100 comprises the reporting services 110 configured to generate report with the final set of areas of improvement in enterprise applications as illustrated below in Table Ha.

TABLE H

| Final | | |
|---|---|---|
| Improvement | | |
| Opportunities | Modules | Recommendations |
| Use Union All | E | Use Union All |
| instead of Union | | |
| Avoid Instantiation | B | Declare the object outside |
| within the loop | | the loop and reuse it |
| Implement the database | | Use default database |
| connection pool | | connection pool |

TABLE Ha

| Final Improvement Opportunities | Applications |
|---|---|
| Use Union All instead of Union | J2EE, .Net |
| Avoid Instantiation within the loop | J2EE, .Net, C, C++, |
| Implement the database connection pool | Oracle, SQL Server, My SQL |

The field learning UI 106 receives feedback on one or more accepted recommendations on implementation approaches from the application team and stores the accepted recommendations in the memory 104 as illustrated below in Table I.

TABLE I

| Final Improvement | | | |
|---|---|---|---|
| Opportunities | Modules | Recommendations | Feedback |
| Use Union All instead of | E | Use Union All | Accepted/ |
| Union | | | Not |
| | | | accepted |
| Avoid Instantiation within | B | Declare the object outside | Accepted/ |
| the loop | | the loop and reuse it | Not |
| | | | accepted |
| Implement the database | | Use default database | Accepted/ |
| connection pool | | connection pool | Not |
| | | | accepted |

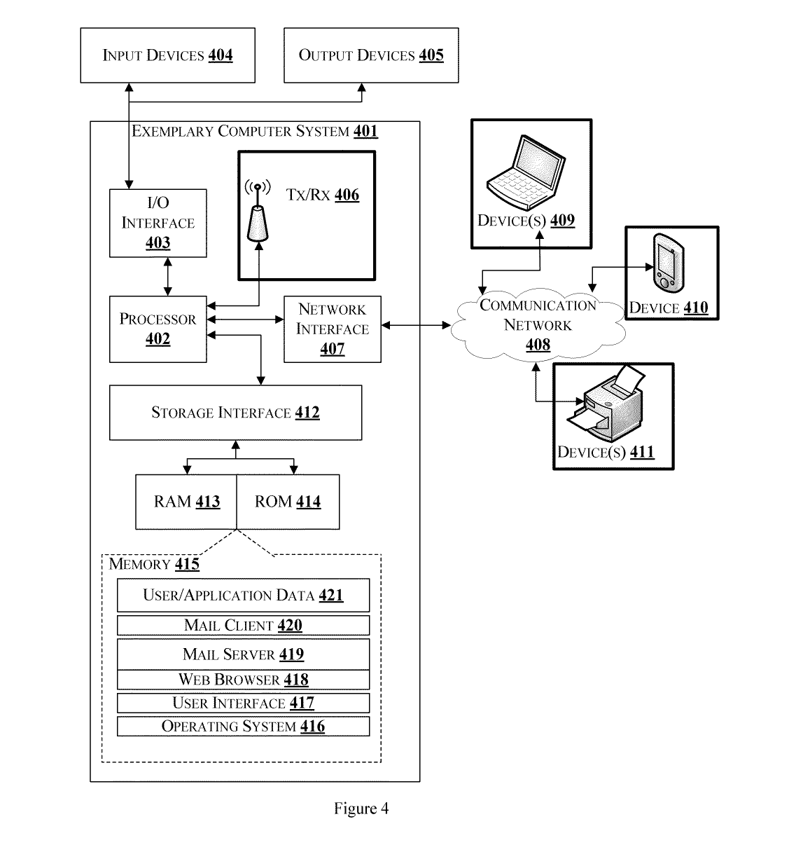

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of identifying areas of improvements in enterprise applications, the method comprising:
receiving, by an application learning user interface (UI) of an identification computing device, static and dynamic analysis data associated with an enterprise application;
receiving, by the identification computing device, one or more responses to one or more questions related to the enterprise application;
analyzing, by the identification computing device, the static and dynamic analysis data and received responses; and
identifying, by the identification computing device, one or more recommended areas of improvements based on the analyzed static and dynamic analysis data and responses corresponding to one or more implementation recommendations stored in a reference repository.

2. The method as claimed in claim 1, further comprising generating, by the identification computing device, an assessment report including the one or more areas of improvements.

3. The method as claimed in claim 1, further comprising:
receiving, by a field learning user interface (UI) of the identification computing device, an acceptance of the implementation recommendations one or more end users; and
storing, by the identification computing device, the implementation recommendations in the reference repository.

4. The method as claimed in claim 1, wherein the one or more questions include questions related to one or more business requirements, one or more deployments, one or more technology or infrastructure requirements, an architecture of application and data, one or more data or security related risks, or management of the enterprise application.

5. The method as claimed in claim 1, further comprising processing, by the identification computing device, the received static and dynamic analysis data and the responses into corresponding processed static and dynamic analysis data and processed responses prior to the analyzing.

6. The method as claimed in claim 1, further comprising:
redefining, by the identification computing device, the one or more questions associated with the enterprise application based on the data received by the application learning UI; and
analyzing, by the identification computing device, the static and dynamic analysis data based on responses received for one or more of the redefined questions.

7. An identification computing device comprising a processor and a memory coupled to the processor which is configured to be capable of executing programmed instructions comprising and stored in the memory to:
receive, by an application learning user interface (UI), static and dynamic analysis data associated with an enterprise application;
receive one or more responses to one or more questions related to the enterprise application;
analyze the static and dynamic analysis data and received responses; and
identify one or more recommended areas of improvements based on the analyzed static and dynamic analysis data and responses corresponding to one or more implementation recommendations stored in a reference repository.

8. The identification computing device as claimed in claim 7, wherein the processor is further configured to be capable of executing at least one additional programmed instructions comprising and stored in the memory to generate an assessment report including the one or more areas of improvements.

9. The identification computing device as claimed in claim 7, wherein the processor is further configured to be capable of executing at least one additional programmed instructions comprising and stored in the memory to:
receive, by a field learning user interface (UI), an acceptance of the implementation recommendations one or more end users; and
store the implementation recommendations in the reference repository.

10. The identification computing device as claimed in claim 7, wherein the one or more questions include questions related to one or more business requirements, one or more deployments, one or more technology or infrastructure requirements, an architecture of application and data, one or more data or security related risks, or management of the enterprise application.

11. The identification computing device as claimed in claim 7, wherein the processor is further configured to be capable of executing at least one additional programmed instructions comprising and stored in the memory to process the received static and dynamic analysis data and the responses into corresponding processed static and dynamic analysis data and processed responses prior to the analyzing.

12. The identification computing device as claimed in claim 7, wherein the processor is further configured to be capable of executing at least one additional programmed instructions comprising and stored in the memory to:
redefine the one or more questions associated with the enterprise application based on the data received by the application learning UI; and
analyze the static and dynamic analysis data based on responses received for one or more of the redefined questions.

13. A non-transitory computer readable medium having stored thereon instructions for identifying areas of improvements in enterprise applications comprising executable code which when executed by at least one processor, causes the processor to perform steps comprising:
receiving, by an application learning user interface (UI), static and dynamic analysis data associated with an enterprise application;
receiving one or more responses to one or more questions related to the enterprise application;
analyzing the static and dynamic analysis data and received responses; and
identifying one or more recommended areas of improvements based on the analyzed static and dynamic analysis data and responses corresponding to one or more implementation recommendations stored in a reference repository.

14. The non-transitory computer readable medium as claimed in claim 13, further having stored thereon instructions comprising executable code which when executed by the processor further causes the processor to perform at least one additional step comprising generating an assessment report including the one or more areas of improvements.

15. The non-transitory computer readable medium as claimed in claim 13, further having stored thereon instructions comprising executable code which when executed by the processor further causes the processor to perform at least one additional step comprising:
receiving, by a field learning user interface (UI), an acceptance of the implementation recommendations one or more end users; and
storing the implementation recommendations in the reference repository.

16. The non-transitory computer readable medium as claimed in claim 13, wherein the one or more questions include questions related to one or more business requirements, one or more deployments, one or more technology or infrastructure requirements, an architecture of application and data, one or more data or security related risks, or management of the enterprise application.

17. The non-transitory computer readable medium as claimed in claim 13, further having stored thereon instructions comprising executable code which when executed by the processor further causes the processor to perform at least one additional step comprising processing the received static and dynamic analysis data and the responses into corresponding processed static and dynamic analysis data and processed responses prior to the analyzing.

18. The non-transitory computer readable medium as claimed in claim 13, further having stored thereon instructions comprising executable code which when executed by the processor further causes the processor to perform at least one additional step comprising:
redefining the one or more questions associated with the enterprise application based on the data received by the application learning UI; and
analyzing the static and dynamic analysis data based on responses received for one or more of the redefined questions.
